(19) United States
(12) Patent Application Publication
(10) Pub. No.: US 2009/0255415 A1
(43) Pub. Date: Oct. 15, 2009

(54) Milk Froth Maker

(75) Inventors: Shengfang CHENG, Tainan (TW); Jinhua LIU, Xiamen (CN)

Correspondence Address: KENING LI;PINSENT MASONS LLP, c/o FOUNTAIN LAW GROUP, INC, 18201 Von Karman Avenue, Suite 960, Irvine, CA, 92612, US

(73) Assignee: TSANN KUEN(CHINA) ENTERPRISE CO., LTD, Xiamen (CN)

(21) Appl. No.: 12/423,785

(22) Filed: Apr. 14, 2009

(30) Foreign Application Priority Data
Apr. 15, 2008 (CN) 200820101983.8

(51) Int. Cl. A47J 43/00; B01F 15/06

(52) U.S. Cl. 99/453; 99/460; 366/145; 366/147

(57) ABSTRACT

A milk froth maker comprising a housing, a container, a heating unit and a control circuit unit mounted in said housing, and a stirring unit set at the top of the housing, said control circuit unit connected to the heating unit and the stirring unit respectively, a bracket unit for supporting the container arranged on the vertical board of the housing, and a temperature sensing unit set on the housing which temperature unit may or may not be in contact with the body of the container, wherein said temperature sensing unit can detect the temperature of the container and output the temperature signal to the control circuit unit for cutting off the power to said heating unit when the sensing signal of the temperature unit reaches a pre-set value.

### CROSS REFERENCES TO RELATED APPLICATIONS

This application claims priority to People's Republic of China Patent Application No. 200820101983.8, filed on Apr. 15, 2008, the entire disclosure of which is incorporated herein by reference.

### FIELD OF THE INVENTION

The present invention relates to a house appliance, and more particularly to a milk froth maker.

### BACKGROUND OF THE INVENTION

A milk froth maker is a device for making milk froth or other hot drinks. A conventional milk froth maker generally comprises a housing, a container, a heating unit and a control-circuit unit mounted in the housing, and a stirring unit set at the top of the housing, wherein the control-circuit unit is connected to the heating unit and the stirring unit respectively so as to control the heating unit and the motor; a stirring rod extends downwardly from the bottom of the stirring unit; a bracket unit for supporting the container is arranged on the housing on a vertical board corresponding to the stirring rod, wherein the bracket unit comprises a bottom bracket for supporting the bottom of the container and an upper bracket for encircling the upper flange of the container, and the container is hung and abutted on the outside of the vertical board of the housing by the co-action of the bottom bracket and the upper bracket; and the stirring rod and a steam jet opening extending out from the heating unit are both contained inside the container. However, the conventional milk froth maker does not have any function for detecting the temperature, and the temperature determination is left to a user's visual judgment or the use of an external thermometer. Because visual judgment is inaccurate, and the use of an external thermometer is complicated and inconvenient, a need exists for an improved milk froth maker.

### SUMMARY OF THE INVENTION

One object of the present invention is to overcome the disadvantages of the conventional milk froth maker and to provide a milk froth maker having a temperature sensing device, by providing a temperature sensors to the housing portion which contacts to the body of the container, so that when the temperature reaches a pre-set value, power will be cut off automatically, achieving automatic temperature-detecting and simplifying the operation.

Thus a milk froth maker of the present invention in one embodiment comprises a temperature sensing device comprising a housing; a container; a heating unit; a control circuit; and a stirring unit set at the top of the housing; a bracket unit for supporting the container arranged on a vertical board of the housing; and a temperature sensing unit, wherein the heating unit and the control circuit unit are both mounted in said housing, the control circuit unit is connected to the heating unit and the stirring unit respectively, and the bracket unit comprises a bottom bracket for supporting the bottom of the container and an upper bracket for encircling the upper flange of the container, the container is hung and abuts on the outside of the vertical board of the housing by the co-action of the bottom bracket and the upper bracket, and the temperature sensing unit detects a temperature signal and outputs the temperature signal to the control circuit unit for cutting off the power to the heating unit when the temperature reaches a per-determiend value.

In one embodiment, the temperature sensing unit is set on the bottom bracket and may or may not be in contact with the bottom of the container.

In one embodiment, the temperature sensing unit is set on the vertical board, and may or may not be in contact with the body of the container.

In one embodiment, the temperature sensing unit is an NTC thermistor. The temperature sensing unit is preferably in contact with the body of the container.

The temperature sensing unit may be an infrared sensing component and disposed not in contact with the body of the container.

The milk froth maker of the present invention comprises a temperature sensing unit to detect the drink temperature in the container automatically. The temperature sensing unit outputs temperature signal to the control circuit unit which evaluates the signal. If the sensing signal reaches a predetermined value, the control circuit unit outputs a control signal for cutting off the power to the heating unit, thus achieving automatic temperature detection and control, and simplifying the operation.

The temperature sensing unit is used for detecting the temperature of the container, i.e. the temperature of the drink in the container. The temperature sensing unit can be mounted in one of two positions. One position is on the vertical board of the housing to detect the temperature of the body of the container. When the steam is being input into the drink in the container, the temperature of the drink rises, and the temperature of the body of the container rises as well. A temperature value corresponding to the body of the container can be pre-set, and when the temperature detected by the temperature sensing unit reaches the pre-set value, the control circuit unit will output a control signal to cut off the power, thus the heating unit will stop generating steam. The other position for the temperature sensing unit is in the bracket unit of the housing, preferably on the bottom bracket, sensing the temperature of the bottom of the container. When the steam is input into the drink in the container, the temperature of the drink rises and the temperature of the bottom of the container rises too. A temperature value corresponding to the bottom of the container can be pre-set. When the temperature detected by the temperature sensing unit reaches the pre-set value, the control circuit unit will output a control signal to cut off the power, thus the heating unit will stop generating steam. Both of the aforementioned two ways can realize automatic power-control by way of detecting the temperature of the container by the temperature sensing unit.

The temperature sensing unit can be a NCT thermistor or infrared sensing component. If an NTC thermistor is used, the temperature sensing unit can be set in the bottom bracket or on the vertical board in contact with the container. When an infrared sensing component is used, the temperature sensing unit can be set in the bottom bracket or vertical board but there is no need for it to be in contact with the container body. As will be readily recognized by an ordinarily skilled artisan, that many other sensing devices are readily available and suitable for the purposes of the present invention.

The present invention has the following advantages: the temperature sensing unit can be set on the vertical board of the housing to detect the temperature of container body or be set on the bracket of the housing (i.e. the bottom bracket) to detect the temperature of the bottom of the container. When the signal sensed reaches a pre-determined value, the temperature sensing unit sends a signal to the control circuit unit which in turn outputs a signal for cutting off the power to the heating unit, thus accomplishing automatic temperature-detection and power control, and simplifying the operation.

### BRIEF DESCRIPTION OF THE DRAWINGS

The advantages and benefits resulting from the milk froth maker having a temperature sensing device of the present invention will become more apparent from the following detailed description and by reference to the accompanying drawings in which:

FIG. 1 is a perspective view of some of the relevant components of a milk froth maker according to one embodiment of the present invention;

FIG.2 is an explosed view of some of the relevant components of a milk froth maker according to one embodiment of the present invention;;

FIG. 3 is a perspective view of some of the relevant components of a milk froth maker according to another embodiment of the present invention;

FIG. 4 is an exploded view of some of the relevant components of a milk froth maker according to one embodiment of the present invention;.

### DETAILED DESCRIPTION OF THE PREFERRED EMBODIMENT

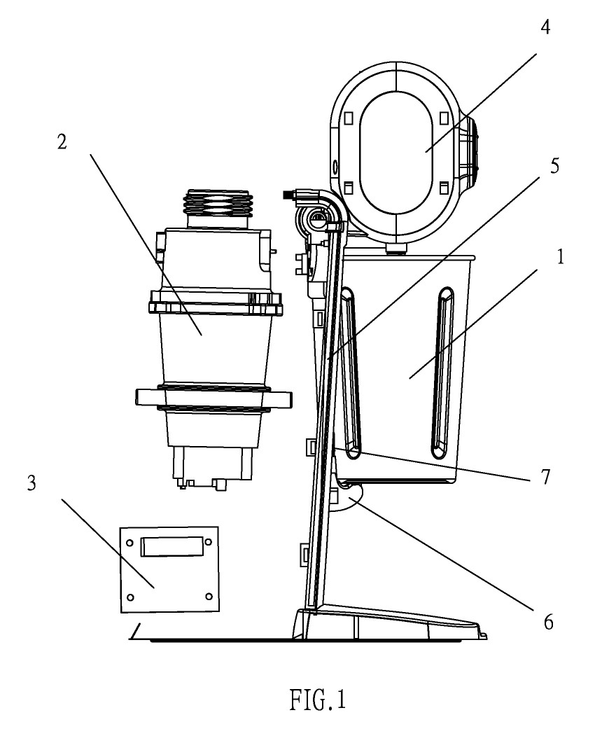

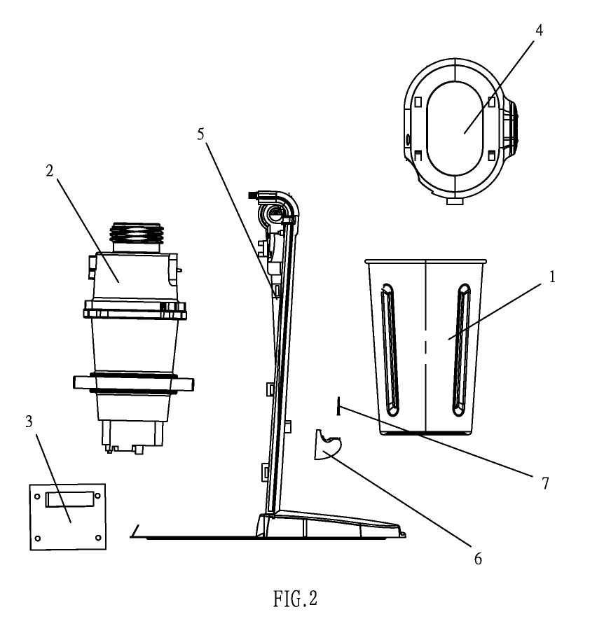

Embodiment 1. Referring to FIG. 1 and FIG. 2, the milk froth maker having a temperature sensing device comprises a housing, a container 1, a heating unit 2 and a control-circuit unit 3 both mounted in the housing, and a stirring unit 4 set on the top of the housing. The control circuit unit 3 is connected to the heating unit 2 and the stirring unit 4 respectively. A bracket unit for supporting the container is arranged on the vertical board 5 of the housing, which bracket unit comprises a bottom bracket 6 for supporting the bottom of the container and an upper bracket for encircling the upper flange of the container. The container 1 is hung and abutted on the outside of the vertical board 5 of the housing by the co-action of the bottom bracket 6 and the upper bracket. A temperature sensing unit 7 is disposed on the housing and is in contact with or in close proximity of the body of the container, wherein the temperature sensing unit detects the temperature signal and outputs the temperature signal to the control circuit unit 3. When the signal indicates that the temperature has reached a pre-set value, the control circuit unit 3 will output a signal for cutting off the power to the heating unit 2.

In one embodiment, the temperature sensing unit 7 is placed on the vertical board 5, and may or may not be in contact with the container body. The temperature sensing unit 7 may be an NCT thermistor or infrared sensing component. If an NTC thermistor is used, the temperature sensing unit 7 can be set on the vertical board and be in contact with the container. If an infrared sensing component is used, the temperature sensing unit 7 can also be set on the vertical board, but not contacting the container body, e.g. the temperature sensing unit 7 can set on the outer side of the vertical board 5, the setting position can be on the top or the bottom of the vertical board 5, or the other positions in which the temperature of the container can be detected by infrared sensing component, but the infrared sensing component does not contact with the container.

According to the present invention, a temperature sensing unit 7 is used on a milk froth maker to detect the drink temperature in the container 1, wherein said temperature sensing unit detects the temperature signal and outputs the temperature signal to the control circuit unit 3. If the temperature reaches a pre-set value, the control circuit unit 3 will output a control signal for cutting off the power to the heating unit 2, thus realizing the automatic temperature detection and simplifying operation.

The temperature sensing unit 7 of the present invention is used for detecting the temperature of the container. i.e. the temperature of the drink in the container. The temperature sensing unit 7 mounted on the vertical board 5 of the housing detects the temperature of the container body. When steam is input into the drink in the container 1, the temperature of the drink will rise and then the temperature of the body of the container 1 will rise too. A temperature value corresponding to the body of the container can be pre-set. When the temperature detected by the temperature sensing unit 7 reaches the pre-set value, the control circuit unit 3 will output a control signal to cut off power, then the heating unit 2 will not generate steam.

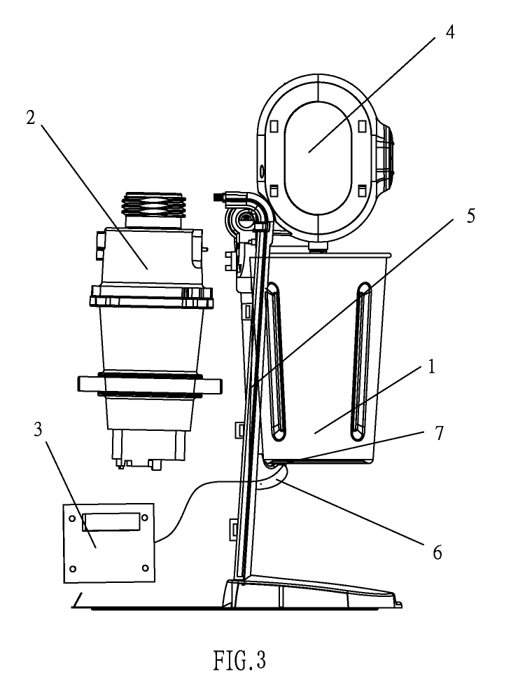

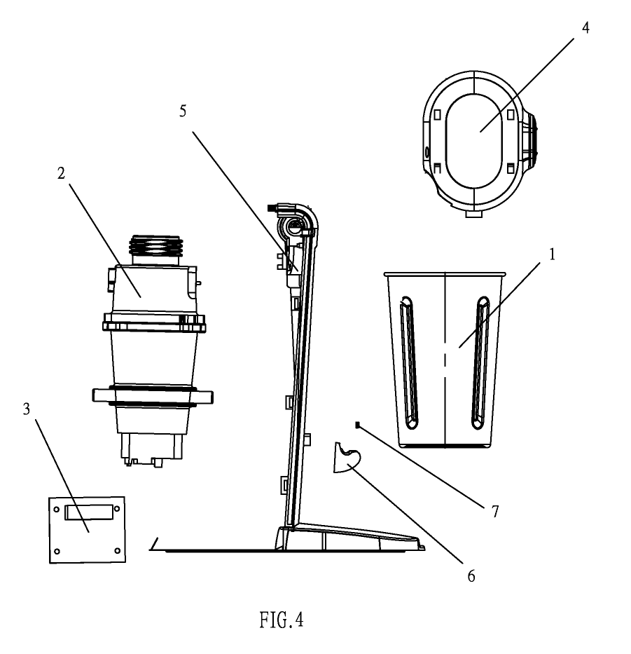

Embodiment 2. Referring to FIG. 3 and FIG. 4, the difference between embodiment 2 and embodiment 1 is that the temperature sensing unit 7 is set on the bottom bracket 6, and can be in contact or not in contact with the bottom of the container. The temperature sensing unit 7 can be an NCT thermistor or infrared sensing component. If an NTC thermistor is used, the temperature sensing unit 7 can be set on the bottom bracket 6 which contacts the bottom of the container. When an infrared sensing component is used, the temperature sensing unit 7 can be set on the bottom bracket as well, but unit not in contacting with the bottom of the container body, e.g. the temperature sensing unit 7 can be set inside the bottom bracket 6 so that it does not contact the bottom of the container. Moreover, the temperature sensing unit 7 can be set on the bottom of the bottom bracket 6 so that the temperature sensing unit 7 will not contact the bottom of the container.

The temperature sensing unit 7 is used for detecting the temperature of the bottom of the container 1. When the steam is input into the drink in the container 1, the temperature of the drink will rise and then the temperature of the body of the container 1 will rise too. A temperature value corresponding to the body of the container can be pre-set, when the temperature detected by the temperature sensing unit 7 reached the pre-set value of the bottom of the container body, the control circuit unit 3 will output a control signal to cut off the power, then the heating unit 2 will not generate steam. Thus realize automatically power-cutting by detecting the temperature of the container by temperature sensing unit 7.

The foregoing description of the preferred embodiments has been presented for the purpose of illustration and description. It is not intended to limit the scope of this invention. Many modifications and variations are possible in light of the above teaching. It should be noted that the present invention can be applied to all kinds of apparatus within the scope of the above presentation.

What is claimed is:

1. A milk froth maker comprising a housing having a vertical board; a mixing container; a heating unit and a control circuit unit mounted in said housing, and a stirring unit set on the top of said housing, wherein said control circuit unit is connected to said heating unit and said stirring unit respectively; a bracket unit for supporting the container wherein said bracket unit is arranged on the vertical board; and a temperature sensing unit mounted on the housing, wherein said temperature sensing unit can detect the temperature of the container and output a temperature signal to said control circuit unit, wherein the control circuit cuts off the power to the heating unit when the sensing signal of the temperature unit reaches a pre-determined value.

2. The milk froth maker according to claim 1, wherein said bracket unit comprises a bottom bracket for supporting the bottom of said container and an upper bracket for encircling an upper flange of the container, wherein said container is hung and abutted on the outside of the vertical board of said housing by the co-action of the bottom bracket and the upper bracket.

3. The milk froth maker according to claim 2, wherein said temperature sensing unit is set on said bottom bracket and is in contact with said container.

4. The milk froth maker according to claim 1, wherein said temperature sensing unit is set on the vertical board of said housing and is in contact with said container.

5. The milk froth maker according to claim 1, wherein said temperature sensing unit is an NTC thermistor.

6. A milk froth maker comprising a housing with a vertical board; a mixing container; a heating unit; a control circuit unit; a stirring unit; a bracket unit for supporting the container, and a temperature sensing unit, wherein the heating unit and the control circuit unit are mounted in said housing, and the stirring unit set on the top of said housing; said control circuit unit is connected to said heating unit and said stirring unit respectively, the bracket unit is arranged on the vertical board of said housing, and the temperature sensing unit is mounted on said housing and does not contact with said container, wherein said temperature sensing unit can detect the temperature of the container, and output a temperature signal to said control circuit unit, which cuts off the power to said heating unit when the temperature reaches a pre-set value.

7. The milk froth maker according to claim 6, wherein said bracket unit comprises a bottom bracket for supporting the bottom of said container and an upper bracket for encircling an upper flange of the container, wherein said container is hung and abutted on the outside of the vertical board of said housing by the co-action of the bottom bracket and the upper bracket.

8. The milk froth maker according to claim 7, wherein said temperature sensing unit is set on said bottom bracket and is not in contact with said container.

9. The milk froth maker according to claim 6, wherein said temperature sensing unit is set on the vertical board of said housing and does not contact said container.

10. The milk froth maker according to claim 6, wherein said temperature sensing unit is an infrared sensing component.
